(19) United States
(12) Patent Application Publication
(10) Pub. No.: US 2024/0297801 A1
(43) Pub. Date: Sep. 5, 2024

(54) BLOCKCHAIN NETWORK USING SMART CONTRACT-BASED MULTI-CHAIN TECHNIQUE, AND PARALLEL EXPANSION METHOD THEREOF

(71) Applicant: ARTIFRIENDS INC., Seongnam-si, Gyeonggi-do (KR)

(72) Inventor: Jung Woo LEE, Daejeon (KR)

(73) Assignee: ARTIFRIENDS INC., Seongnam-si, Gyeonggi-do (KR)

(21) Appl. No.: 18/575,141

(22) PCT Filed: Jun. 22, 2022
(86) PCT No.: PCT/KR2022/008904

§ 371 Date: Dec. 28, 2023

(30) Foreign Application Priority Data
Jun. 30, 2021 (KR) 10-2021-0085986
Jun. 21, 2022 (KR) 10-2022-0075845

(51) Int. Cl. H04L 9/00

(52) U.S. Cl. CPC H04L 9/50

(57) ABSTRACT

Provided is a parallel expansion method of a blockchain network using a smart contract-based multi-chain technique, the method including: a) assuming that any blockchain networks X and Y operating separately exist; b) generating, by validators of the blockchain network X, a node of the blockchain network Y, the node participating in the blockchain network Y; c) generating, by validators of the blockchain network Y, a node of the blockchain network X, the node participating in the blockchain network X; and d) defining the nodes respectively generated in the steps b) and c) as supervisor nodes, and processing a contract based on a status between the blockchain network X and the blockchain network Y.

Furthermore, the method further includes proposing, by each of the validators, a decision on the contract on the basis of block data of the supervisor node of the counterpart network when the contract is processed in the step d), wherein the block data is owned by each of the validators.

### BACKGROUND OF THE INVENTION

### Field of the Invention

The present disclosure relates to a parallel expansion method of a blockchain network. More particularly, the present disclosure relates to a blockchain network using a smart contract-based multi-chain technique and a parallel expansion method of the blockchain network, wherein unlimited parallel expansion of a blockchain network is supported by introducing a smart contract-based multi-blockchain structure.

### Description of the Related Art

As the number of blockchain users increases, status data that a blockchain network must keep also increases relatively. Such an increase in the status data cannot be solved by division of block data according to time, and it is difficult to process verification of different blockchain networks in real time.

Bitcoin having a single chain structure has a 1 MB block capacity limit and a block generation period within 10 minutes, in terms of design. Bitcoin has faced a problem with expansion caused by an increase in the number of users, and attempts were made to solve the problem by introducing a Bitcoin-based multi-chain.

Ethereum having another single chain structure supports smart contracts, which are not supported by Bitcoin, and has partially solved the existing problem of Bitcoin. However, because of increased usage, there is a problem with expansion as in Bitcoin.

Bitcoin, an existing blockchain technology, uses a single chain method and currently supports only about 300,000 transactions per day (data in megabytes that can be processed every 10 minutes) because of the limitation on the amount of data that can be processed on a network. In addition, the current standard fee for Bitcoin is 0.0001 BTC, which may seem low, but if the demand for Bitcoin trading exceeds the supply, the fee may increase significantly and may become an obstacle to network expansion.

To solve the problem, a Bitcoin-based multi-chain blockchain is introduced, so that unlimited capacity is achieved, a problem with transaction cost is solved, and mining risk is reduced, but smart contracts are not supported.

Ethereum, another blockchain technology, supports smart contracts and has a rapidly improved speed compared to Bitcoin, but gas consumed for transactions is fixed and the gas fee has increased in proportion to an increase in the number of network users. To solve the problem, Ethereum has introduced methods, such as sharding, for improvement, but has not yet achieved satisfactory results.

In the meantime, Korean Patent Application Publication No. 10-2019-0009958 (Patent Document 1) discloses “EXPANDABLE BLOCKCHAIN SYSTEM AND BLOCKCHAIN EXPANSION METHOD”. The blockchain expansion method includes: generating, by an expandable blockchain system, a plurality of sub-networks by dividing a network and a plurality of nodes on the basis of a predetermined criterion; connecting, by bridges of the expandable blockchain system, the sub-networks to each other so that the nodes included in each of the sub-networks conduct transactions in the corresponding sub-network or between the corresponding sub-network and the others; generating, by at least part of the nodes in each of the sub-networks, sub-blocks and a sub-blockchain for recording at least part of the transactions and data related to the transactions occurring between the nodes; and connecting, by each of the bridges, the sub-blocks and the sub-blockchain belonging to one of the sub-networks with the sub-blocks and the sub-blockchain belonging to another one of the sub-networks, and sharing together, by at least part of the nodes, united blocks and a main blockchain in which the united blocks are connected, wherein the united blocks are obtained by expanding block capacity in proportion to the number of the connected sub-blocks.

In the case of Patent Document 1, the entire network system is divided into sub-networks and sub-blockchains are unlimitedly generated, so that the capacity of a main block that is the sum of sub-blocks is greatly expanded and blockchains are updated without delay for many transactions. However, because of the mechanism in which the network and the plurality of nodes are simply divided to generate the plurality of sub-network and the sub-networks are connected to each other so that the nodes included in each of the sub-networks conduct transactions in the corresponding sub-network or between the corresponding sub-network and the others, when a multi-chain transaction is generated, it is difficult for a validator node to determine whether to process the transaction as the validator node does not include a supervisor node that uses the same private key in the network to which the validator node does not belong.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing a blockchain network using a smart contract-based multi-chain technique, and a parallel expansion method of the blockchain network, wherein a smart contract-based multi-blockchain structure is introduced so that a block validator node includes a supervisor node that uses the same private key in the network to which the block validator node does not belong, and when a multi-chain transaction is generated, whether to process the transaction is determined on the basis of the data kept in the supervisor node, thereby supporting unlimited parallel expansion of blockchain networks.

According to the present disclosure, there is provided a parallel expansion method of a blockchain network using a smart contract-based multi-chain technique,

the method including each step performed by a computer system or the blockchain network, and including:
a) assuming that any blockchain networks X and Y operating separately exist;
b) generating, by validators of the blockchain network X, a node of the blockchain network Y, the node participating in the blockchain network Y;
c) generating, by validators of the blockchain network Y, a node of the blockchain network X, the node participating in the blockchain network X; and
d) defining the nodes respectively generated in the steps b) and c) as supervisor nodes, and processing a contract based on a status between the blockchain network X and the blockchain network Y.

Herein, the method may further include proposing, by each of the validators, a decision on the contract on the basis of block data of the supervisor node of the counterpart network when the contract is processed in the step d), wherein the block data is owned by each of the validators.

In addition, in the step a), the blockchain network X may include: a light node that is a blockchain node that general users use; a validator node holding nodes that use the same private keys as in the network not belonging to the blockchain network X for the validator node; and the supervisor node that is a node defined as nodes generated using nodes of the blockchain network Y, wherein the nodes of the blockchain network Y participate therein.

In addition, in the step a), the blockchain network Y may include: a light node that is a blockchain node that general users use; a validator node holding nodes that use the same private keys as in the network not belonging to the blockchain network Y for the validator node; and the supervisor node that is a node defined as nodes generated using nodes of the blockchain network X, wherein the nodes of the blockchain network X participate therein.

In addition, in processing the contract between the blockchain network X and the blockchain network Y in the step d), two contracts may be combined not to break consistency

Herein, among the two contracts, the contract on one side may perform a function of proposing and the contract on the other side may perform a function of finalizing.

In addition, the light node may include a unique private key and a tracer, and may be capable of transaction generation and request, and result inquiry.

According to the present disclosure, there is provided a blockchain network using a smart contract-based multi-chain technique, the blockchain network including:
a light node that is a blockchain node that general users use;
a validator node holding nodes that use the same private keys as in a network Y not belonging to a network X for the validator node; and
a supervisor node that is a node defined as nodes generated using nodes of the network Y, wherein the nodes of the network Y participate therein.

Herein, the light node may include a unique private key and a tracer.

In addition, the validator node may be a node that is approved to participate in consensus after all existing blockchains are synchronized, and decision-making consensus may use a SASEUL consensus algorithm.

In addition, the validator node may be configured to communicate directly with the light node, to periodically perform hashing on a generated block, and to transfer a block resulting from hashing to an arbiter.

In addition, the supervisor node may be a node in which all existing blockchains are synchronized, and may be configured to determine whether the network generates a correct block, and to store a result of determination.

In addition, preferably, the blockchain network further includes an arbiter node serving as a storage in which all blockchains are stored.

Herein, the arbiter node may be configured not to participate in decision making.

Herein, the arbiter node may be configured to transmit data only when validators request validation or comparison with historical records is required.

In addition, when a multi-chain transaction is generated, the validator node may be configured to determine whether to process the transaction, on the basis of data kept in the supervisor node.

According to the present disclosure, the smart contract-based multi-blockchain structure is introduced so that a block validator node includes a supervisor node that uses the same private key in the network to which the block validator node does not belong, and when a multi-chain transaction is generated, whether to process the transaction is determined on the basis of the data kept in the supervisor node, thereby supporting unlimited parallel expansion of blockchain networks.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram showing a Bitcoin-based multi-chain structure of a conventional blockchain system;

FIG. 2 is a diagram schematically showing a sharding technique for expanding a storage space of Ethereum;

FIG. 3 is a diagram showing a simple structure of the shard chains of FIG. 2 and the operation thereof;

FIG. 4 is a flowchart showing a parallel expansion method of a blockchain network using a smart contract-based multi-chain technique according to the present disclosure; and

FIG. 5 is a diagram showing a multi-chain structure of SASEUL employed to implement a parallel expansion method of a blockchain network using a smart contract-based multi-chain technique according to the present disclosure.

### DETAILED DESCRIPTION OF THE INVENTION

The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the best method he or she knows for carrying out the disclosure.

Throughout the specification, when a part “includes” an element, it is noted that it further includes other elements, but does not exclude other elements, unless specifically stated otherwise. Also, the terms “ . . . part”, “ . . . unit”, “module”, “device”, and the like mean a unit for processing at least one function or operation and may be implemented by hardware, software, or a combination of hardware and software.

Hereinafter, embodiments of the present disclosure will be described with reference to the accompanying drawings.

Here, before describing the embodiments of the present disclosure, an existing Bitcoin-based multi-chain structure and a sharding technique for expanding a storage space of Ethereum will be described first to help the understanding of the present disclosure in relation to a smart contract-based multi-blockchain structure introduced in the present disclosure.

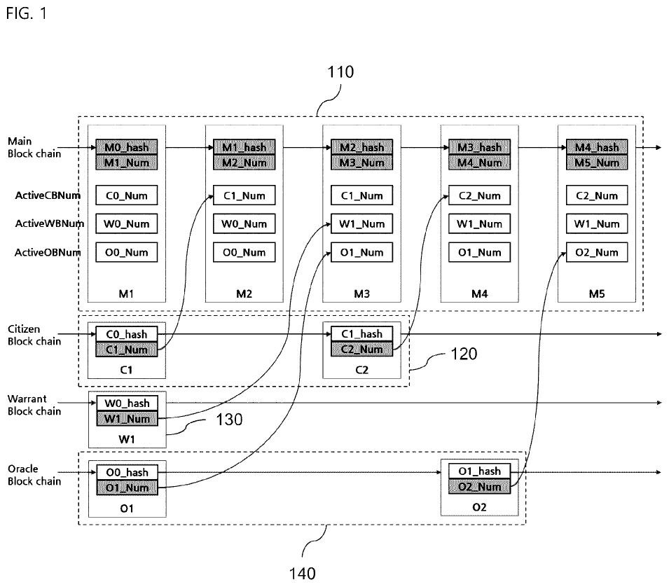

FIG. 1 is a diagram showing a Bitcoin-based multi-chain structure of a conventional blockchain system.

Referring to FIG. 1, the conventional Bitcoin-based multi-chain structure includes a main blockchain 110 for storing transaction details, and a Citizen blockchain 120, a Warrant blockchain 130, and an Oracle blockchain 140 that are sub-blockchains related to blockchain operation.

A main blockchain M1 to M5 110 refers to a main blockchain among chains constituting a multi-chain, and refers to Bitcoin in the present disclosure. The expressions “M0_hash” to

“M4_hash” mean blocks having hash information among blocks of the main blockchain, Bitcoin. The expressions “M1_Num” to “M5_Num” mean blocks having data (ledger information, etc.) among blocks of the Oracle blockchain. Furthermore, the expression “ActiveCBNum” denotes blocks included in the main blockchain among data blocks of the Citizen blockchain. The expression “ActiveWBNum” denotes blocks included in the main blockchain among data blocks of the Warrant blockchain. The expression “ActiveOBNum” denotes blocks included in the main blockchain among data blocks of the Oracle blockchain.

The Citizen blockchain C1 and C2 120 is a blockchain developed by Citizen and means a sub-blockchain of the multi-chain. The expressions “C0_hash” and “C1_hash” mean blocks having hash information among blocks of the Citizen blockchain. The expressions “C1_Num” and “C2_Num” mean blocks having data (ledger information, etc.) among blocks of the Citizen blockchain.

The Warrant blockchain W1 130 is a blockchain developed by Warrant and means a sub-blockchain of the multi-chain. The expression “W0_hash” means a block having hash information among blocks of the Warrant blockchain. The expression “W1_Num” means a block having data (ledger information, etc.) among blocks of the Warrant blockchain.

The Oracle blockchain O1 and O2 140 is a blockchain developed by Oracle and means a sub-blockchain of the multi-chain. The expressions “O0_hash” and “O1_hash” mean blocks having hash information among blocks of the Oracle blockchain. The expressions “O1_Num” and “O2_Num” mean blocks having data (ledger information, etc.) among blocks of the Oracle blockchain.

The conventional Bitcoin-based multi-chain structure as described above has succeeded in separation into the main blockchain 110, the Citizen blockchain 120, the Warrant blockchain 130, and the Oracle blockchain 140, and the relationship thereof has a shape as if tendrils twined with respect to the main blockchain 110 as shown in the figure.

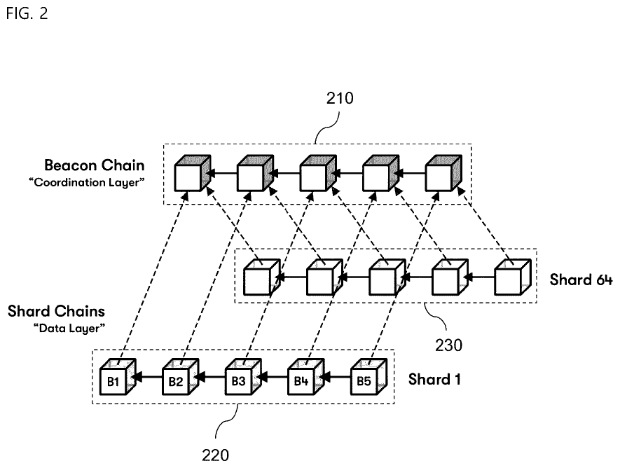

FIG. 2 is a diagram schematically showing a sharding technique for expanding a storage space of Ethereum.

Referring to FIG. 2, a beacon chain 210 is the core of Ethereum 2.0 and is a blockchain in the format in which validators build a blockchain by using a staking system without miners.

Shard chains 220 do not process any operations and only perform a function of storing any data. The blocks in which any data are stored according to each block capacity are denoted by B1 to B5.

The number of shard chains to be introduced in Ethereum 2.0 is denoted by “Shard 64” 230. The number was planned to be 1024 at the time of introduction, but was adjusted to 64 in Phase 1 by simplifying the structure.

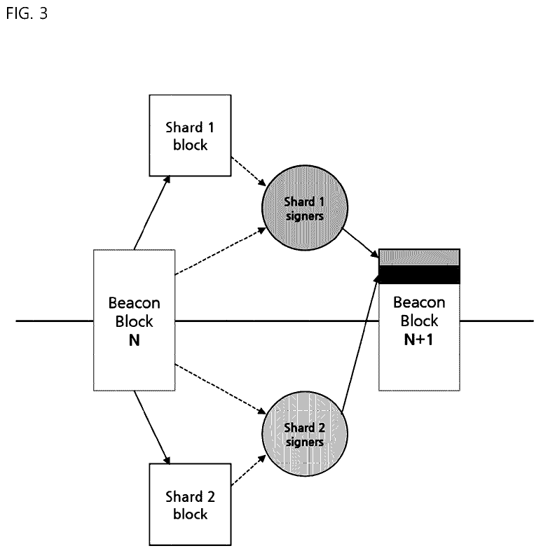

FIG. 3 is a diagram showing a simple structure of the shard chains of FIG. 2 and the operation thereof.

Referring to FIG. 3, for example, simply assuming that there are two shard chains, blocks of all the shard chains are included in each beacon block as shown in FIG. 3. The blocks of slots N+1 of all the shards are capable of checking the blocks of slots N of all the shards. Accordingly, single-slot cross-shard communication is achieved through a Merkle receipt.

Hereinafter, based on the above description, embodiments of the present disclosure will be described.

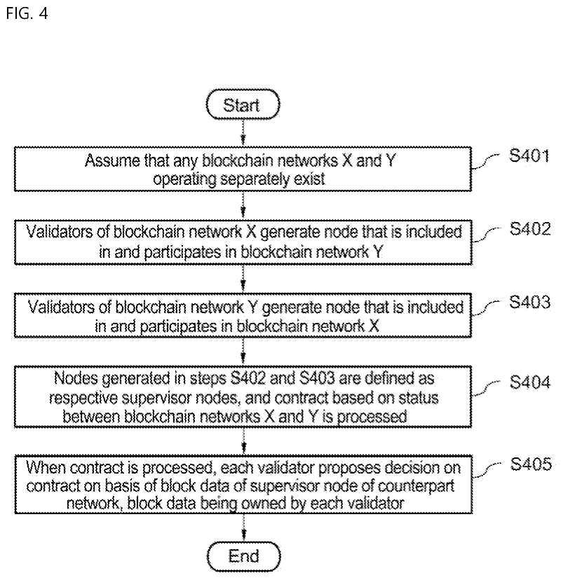

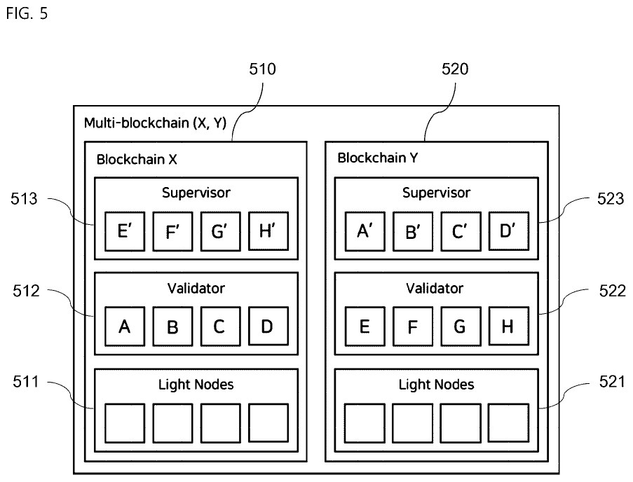

FIG. 4 is a flowchart showing a parallel expansion method of a blockchain network using a smart contract-based multi-chain technique according to an embodiment of the present disclosure. FIG. 5 is a diagram showing a multi-chain structure of SASEUL employed to implement a parallel expansion method of a blockchain network using a smart contract-based multi-chain technique according to the present disclosure.

Referring to FIGS. 4 and 5, the parallel expansion method of the blockchain network using the smart contract-based multi-chain technique according to the present disclosure includes each step performed by a computer system or the blockchain network. First, it is assumed that any blockchain networks X and Y 510 and 520 operating separately exist in step S401.

Herein, the blockchain network X 510 may include a light node 511, a validator node 512, and a supervisor node 513. The light node 511 is a blockchain node that general users use. The validator node 512 holds nodes that use the same private keys as in the network (here, the blockchain network Y 520) not belonging to the network X for the validator node 512. The supervisor node 513 is a node that is defined as nodes generated using nodes of the blockchain network Y 520, wherein the nodes of the blockchain network Y 520 participate therein. The blockchain network Y 520 may include a light node 521, a validator node 522, and a supervisor node 523. The light node 521 is a blockchain node that general users use. The validator node 522 holds nodes that use the same private keys as in the network (herein, the blockchain network X 510) not belonging to the network Y for the validator node 522. The supervisor node 523 is a node that is defined as nodes generated using nodes of the blockchain network X 510, wherein the nodes of the blockchain network X 510 participate therein.

After the assumption of any blockchain networks X and Y 510 and 520 operating separately, validators of the blockchain network X 510 generate a node of the blockchain network Y 520 in step S402, wherein the node participates therein.

Similarly, validators of the blockchain network Y 520 generate a node of the blockchain network X 510 in step S403, wherein the node participates therein.

Next, the nodes generated in steps S402 and S403 are defined as the supervisor nodes 513 and 523, respectively, and a contract based on the status between the blockchain network X 510 and the blockchain network Y 520 is processed in step S404. Herein, in processing the contract between the blockchain network X 510 and the blockchain network Y 520, two contracts may be combined not to break consistency. Herein, among the two contracts, the contract on one side performs a function of proposing and the contract on the other side performs a function of finalizing. Herein, preferably, in order for a new network participant to validate a block correctly, block data of the two networks X and Y should be managed by existing network participants so as not to be lost.

Afterward, when the contract is processed, each of the validator nodes 512 and 522 proposes a decision on the contract in step S405 on the basis of the block data of the supervisor node 523 or 513 of the counterpart network, wherein the block data is owned by the validator node 512 or 522.

Here, in relation to the multi-chain structure of SASEUL of FIG. 5, a further description will be given.

In FIG. 5, the light nodes 511 and 521 are the most basic and concise nodes included in the networks. The light nodes 511 and 521 are the nodes that are connected directly with actual services, such as a blockchain wallet, and are used by end users who do not make any network contributions. The light nodes 511 and 521 include unique private keys and tracers, and are capable of transaction generation and request, and result inquiry.

The validator nodes 512 and 522 are nodes that are approved to participate in consensus after all existing blockchains are synchronized. The validator nodes 512 and 522 receive transaction requests generated on the respective networks, reach consensus on approval or disapproval, and generate data in the form of a block. Decision-making consensus is made by a SASEUL consensus algorithm. The validator nodes 512 and 522 communicate directly with the light nodes 511 and 521, respectively, and periodically perform hashing on the generated blocks and transfer the resulting blocks to an arbiter. Furthermore, when multi-chain transactions are generated, the validator nodes 512 and 522 may determine whether to process the transactions, on the basis of the data kept in the supervisor nodes, which will be described later. Here, the SASEUL consensus algorithm will be described in detail.

In order to implement a completely decentralized public network of Proof of Work (PoW), which is a previous-generation blockchain consensus algorithm, while solving the weak point that is low speed, and in order to solve the weak point of Proof of Stake (PoS) that is allowed to be implemented only in the form of a private network because POS cannot be used alone, the SASEUL consensus algorithm employs a double-chain structure in which PoW and PoS are combined. The SASEUL consensus algorithm uses a consensus algorithm, called a hypothesis acceptance procedure, to improve the security of the validator node. Herein, the hypothesis acceptance procedure is as follows.

First, a validator generates a hypothesis including a block to be generated later with a signature of the validator. After that, all nodes continuously synchronize the hypothesis including the signature of the validator. In the synchronization process, when different hypotheses are generated, the hypotheses are merged to generate a high-level hypothesis. Herein, the high-level hypothesis must include signatures of a larger number of validators. Afterward, the validator that has generated a dual signature is excluded from block consensus. Herein, the same number of validator signatures are included, but when the values are different, this is determined as malicious. Finally, when the same validator hypotheses equal to or greater than a quorum are synchronized, the block is confirmed.

The supervisor nodes 513 and 523 are nodes in which all existing blockchains are synchronized, and are nodes in which setting for monitoring is made, apart from nodes within the service of the light nodes. The supervisor nodes 513 and 523 determines whether the respective networks generate correct blocks, and stores a result of determination. Furthermore, the supervisor nodes 513 and 523 are capable of detecting problems, such as generation of an incorrect hash, but incapable of performing functions that directly affect the networks, such as directly generating transactions for confirmation and punishment.

An arbiter node (not shown) is a storage node in which all blockchains are stored. The arbiter node is a node that does not participate in decision making, and transmits data out only when comparison with historical records is required, such as validators request validation.

The validator node 512 of the blockchain network X holds nodes A, B, C, and D that use the same private keys as in the network (here, the blockchain network Y) not belonging to the blockchain network X on the basis of the network X.

Similarly, the validator node 522 of the blockchain network Y holds nodes E, F, G, and H that use the same private keys as in the network (herein, the blockchain network X) not belonging to the blockchain network Y on the basis of the network Y.

The supervisor node 513 of the blockchain network X includes nodes E′, F′, G′, and H′ that are defined by nodes E, F, G, and H generated using nodes of the blockchain network Y on the basis of the blockchain network X, wherein the nodes of the blockchain network Y participate therein.

The supervisor node 523 of the blockchain network Y includes nodes A′, B′, C′, and D′ that are defined by nodes A, B, C, and D generated using nodes of the blockchain network X on the basis of the blockchain network Y, wherein the nodes of the blockchain network X participate therein.

As described above, according to the blockchain network using the smart contract-based multi-chain technique and the parallel expansion method of the blockchain network according to the present disclosure, the smart contract-based multi-blockchain structure is introduced so that a block validator node includes a supervisor node that uses the same private key in the network to which the block validator node does not belong, and when a multi-chain transaction is generated (which means that a transaction is generated on at least two or more blockchains and is processed), whether to process the transaction is determined on the basis of the data kept in the supervisor node, thereby supporting unlimited parallel expansion of blockchain networks.

Although an exemplary embodiment of the present disclosure has been described in detail, the present disclosure is not limited thereto, and it is obvious to those skilled in the art that various modification and applications can be made within the scope of the technical idea of the present disclosure. Accordingly, the true scope of the present disclosure should be interpreted by the following claims, and all technical ideas within the scope equivalent thereto should be interpreted as being included in the scope of the present disclosure.

1. A parallel expansion method of a blockchain network using a smart contract-based multi-chain technique, the method comprising the steps, each performed by a computer system or the blockchain network, of:
a) assuming that any blockchain networks X and Y operating separately exist;
b) generating, by validators of the blockchain network X, a node of the blockchain network Y, the node participating in the blockchain network Y;
c) generating, by validators of the blockchain network Y, a node of the blockchain network X, the node participating in the blockchain network X; and
d) defining the nodes respectively generated in the steps b) and c) as supervisor nodes, and processing a contract based on a status between the blockchain network X and the blockchain network Y.

2. The method of claim 1, further comprising proposing, by each of the validators, a decision on the contract on the basis of block data of the supervisor node of the counterpart network when the contract is processed in the step d), wherein the block data is owned by each of the validators.

3. The method of claim 1, wherein in the step a), the blockchain network X comprises:
a light node that is a blockchain node that general users use;
a validator node holding nodes that use the same private keys as in the network not belonging to the blockchain network X for the validator node; and
the supervisor node that is a node defined as nodes generated using nodes of the blockchain network Y, wherein the nodes of the blockchain network Y participate therein.

4. The method of claim 1, wherein in the step a), the blockchain network Y comprises:
a light node that is a blockchain node that general users use;
a validator node holding nodes that use the same private keys as in the network not belonging to the blockchain network Y for the validator node; and
the supervisor node that is a node defined as nodes generated using nodes of the blockchain network X, wherein the nodes of the blockchain network X participate therein.

5. The method of claim 1, wherein in processing the contract between the blockchain network X and the blockchain network Y in the step d), two contracts are combined not to break consistency.

6. The method of claim 5, wherein among the two contracts, the contract on one side performs a function of proposing and the contract on the other side performs a function of finalizing.

7. The method of claim 3, wherein the light node includes a unique private key and a tracer, and is capable of transaction generation and request, and result inquiry.

8. A blockchain network using a smart contract-based multi-chain technique, the blockchain network comprising:
a light node that is a blockchain node that general users use;
a validator node holding nodes that use the same private keys as in a network Y not belonging to a network X for the validator node; and
a supervisor node that is a node defined as nodes generated using nodes of the network Y, wherein the nodes of the network Y participate therein.

9. The blockchain network of claim 8, wherein the light node includes a unique private key and a tracer.

10. The blockchain network of claim 8, wherein the validator node is a node that is approved to participate in consensus after all existing blockchains are synchronized, and decision-making consensus uses a SASEUL consensus algorithm.

11. The blockchain network of claim 8, wherein the validator node is configured to communicate directly with the light node, to periodically perform hashing on a generated block, and to transfer a block resulting from hashing to an arbiter.

12. The blockchain network of claim 8, wherein the supervisor node is a node in which all existing blockchains are synchronized, and is configured to determine whether the network Y generates a correct block, and to store a result of determination.

13. The blockchain network of claim 8, further comprising an arbiter node serving as a storage in which all blockchains are stored.

14. The blockchain network of claim 13, wherein the arbiter node is configured not to participate in decision making.

15. The blockchain network of claim 13, wherein the arbiter node is configured to transmit data only when validators request validation or comparison with historical records is required.

16. The blockchain network of claim 8, wherein when a multi-chain transaction is generated, the validator node is configured to determine whether to process the transaction, on the basis of data kept in the supervisor node.

17. The method of claim 4, wherein the light node includes a unique private key and a tracer, and is capable of transaction generation and request, and result inquiry.
